(19) United States
(12) Patent Application Publication
(10) Pub. No.: US 2011/0202852 A1
(43) Pub. Date: Aug. 18, 2011

(54) METHOD AND APPARATUS FOR PROVIDING SOCIAL NETWORK SERVICE WIDGETS

(75) Inventors: Jin-woo JEONG, Gunpo-si (KR); Soon-hwan Hong, Seoul (KR); Pil-eun Yang, Seoul (KR)

(73) Assignee: Samsung Electronics Co., Ltd., Suwon-si (KR)

(21) Appl. No.: 13/026,722

(22) Filed: Feb. 14, 2011

(30) Foreign Application Priority Data
Feb. 12, 2010 (KR) 10-2010-0013648

(51) Int. Cl. G06F 3/01; G06F 15/16

(52) U.S. Cl. 715/751

(57) ABSTRACT

A method of providing a Social Network Service (SNS) widget includes receiving SNS service information from a plurality of external SNS servers, and integrating the received SNS service information into the widget.

### PRIORITY

This application claims priority to Korean Patent Application No. 10-2010-0013648, filed on Feb. 12, 2010, in the Korean Intellectual Property Office, the contents of which are incorporated herein by reference.

### BACKGROUND OF THE INVENTION

1. Field of the Invention

The present invention relates generally to a method and apparatus for providing Social Network Service (SNS) widgets, and more particularly, to a method and apparatus for providing SNS widgets integrated from each SNS widget.

2. Description of the Related Art

Widgets denote Graphic User Interfaces (GUIs) that provide a unique method for a user who desires to interact with an operating system or an application. Currently, users of portable devices such as computers or mobile devices may easily access useful information such as clock, weather, and the like through widgets. The widget is currently formed to provide only one piece of information according to each platform, which is inconvenient to users.

### SUMMARY OF THE INVENTION

The present invention provides a method and apparatus for providing widgets that integrally manage Social Network Services (SNSs).

According to an aspect of the present invention, there is provided a method of providing an SNS widget, including receiving SNS service information from a plurality of external SNS servers, and integrating the received SNS service information into the widget.

According to another aspect of the present invention, there is provided an apparatus for providing SNS widgets, including a display unit for displaying the SNS widgets, a communication unit for receiving SNS service information from a plurality of external SNS servers, and a control unit for integrating the received SNS service information into the widgets.

### BRIEF DESCRIPTION OF THE DRAWINGS

The above and other features and advantages of the present invention will become more apparent by describing in detail embodiments thereof with reference to the attached drawings in which:

FIG. 1 illustrates an apparatus for providing SNS widgets, according to an embodiment of the present invention;

FIG. 2 illustrates a user interface for displaying and managing an integrated SNS widget according to an embodiment of the present invention;

FIG. 3 illustrates a user interface to which information may be input according to an embodiment of the present invention;

FIG. 4 is illustrates an interface screen related to a limitation in a number of letters; and

FIG. 5 illustrates a method of providing SNS widget, according to an embodiment of the present invention.

### DETAILED DESCRIPTION OF EMBODIMENTS OF THE INVENTION

Hereinafter, the present invention will be described in detail by explaining embodiments of the invention with reference to the attached drawings. Like reference numerals in the drawings denote like elements. In the following description of the present invention, a detailed description of known functions and configurations incorporated herein will be omitted for clarity and conciseness.

An integrated Social Network Service (SNS) widget denotes a widget that integrates each SNS widget into one widget and feed information denotes SNS service information received from a SNS server.

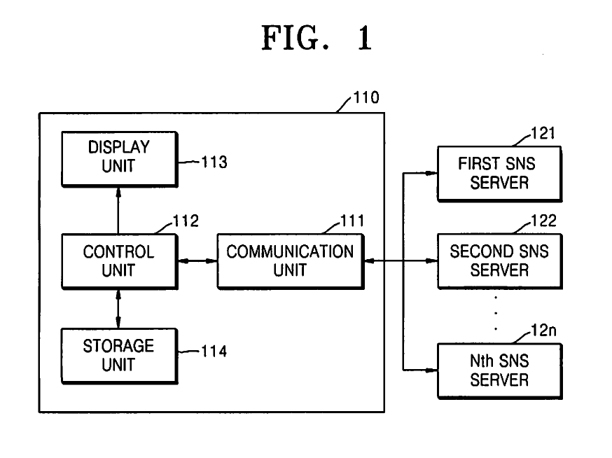

FIG. 1 illustrates an apparatus 110 for providing SNS widgets, according to an embodiment of the present invention.

The apparatus 110 includes a communication unit 111, a control unit 112, a display unit 113, and a storage unit 114, and is connected to a plurality of external SNS servers 121 through 12n, which provide SNS service information through a communication network.

Referring to FIG. 1, the communication unit 111 receives SNS service information from the plurality of external SNS servers 121 through 12n. The communication unit 111 may communicate with the plurality of external SNS servers 121 through 12n by a wireless network, such as a cellular telephone network, a Wireless Local Area Network (LAN), and/or a Metropolitan Area Network (MAN), Intranet, the Internet or World Wide Web (WWW), or wireless communication with other devices. The wireless communication may include Global System for Mobile Communications (GSM), Enhanced Data GSM Environment (EDGE), High-Speed Downlink Packet Access (HSDPA), Wideband Code Division Multiple Access (W-CDMA), Code Division Multiple Access (CDMA), Time Division Multiple Access (TDMA), Bluetooth®, Wireless Fidelity (Wi-Fi), such as IEEE 802.11a, IEEE 802.11b, IEEE 802.11g, and/or IEEE 802.11n, Voice over Internet Protocol (VoIP), an e-mail protocol, such as Internet Message Access Protocol (IMAP) and/or Post Office Protocol (POP), instant messaging, such as eXtensible Messaging and Presence Protocol (XMPP), Session Initiation protocol for instant Messaging and Presence Leveraging Extensions (SIMPLE), Instant Messaging and Presence Service (IMPS), and/or Short Message Service (SMS), or another appropriate communication protocol including a communication protocol that is not developed at the time of filing this application. However, the present invention is not limited thereto and any of a plurality of communication standards, protocols, and technologies may be used.

The control unit 112 integrates the received SNS service information into widgets. Accordingly, the apparatus 110 for providing SNS widgets may provide integrated SNS widgets.

The control unit 112 may select some of the SNS servers from the plurality of external SNS servers 121 through 12n based on users selection and may control to receive SNS service information from the selected SNS servers.

The control unit 112 provides update buttons or the SNS service information to SNS integrated widgets. When a user selects the update button, the control unit 112 controls to newly receive SNS service information from the plurality of external SNS servers 121 through 12n. In addition, as an automatic updating method, the control unit 112 may control to periodically receive external SNS service information according to a time interval and to display the plurality of external SNS service information.

The control unit 112 provides an area to the integrated SNS widgets so that a user may input information. When the user inputs data to the input area, the data input by the user may simultaneously upload to the plurality of external SNS servers 121 through 12n.

When an amount of information input by a user exceeds a threshold value set in an SNS server having a limitation in an amount of information, the control unit 112 controls to not upload the data input by the user to the SNS server having limitation in an amount of information, and a unique icon for the SNS server having the amount of information limitation is controlled to be dimmed.

The display unit 113 displays provided widgets, and may include a touch screen (not illustrated) having a touch-sensing surface sensor that receives an input from a user based on haptic contact and/or tactile contact.

The storage unit 114 may store various received or input data and various applications, include a Read Only Memory (ROM) or a Random Access Memory (RAM), and include non-volatile memories, such as at least one of a magnetic disk storage device, a flash memory device and a non-volatile solid-state memory device.

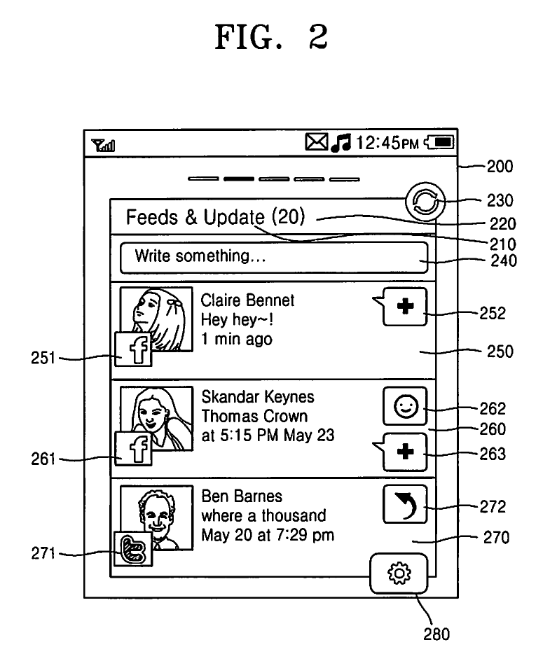

FIG. 2 illustrates a user interface for displaying and managing an integrated SNS widget according to an embodiment of the present invention.

“Feeds & Update” 210 indicates a widget logo of an integrated SNS widget 200, which logo may be set by a manufacturer of a widget provider.

“20” 220 indicates a number of updated feeds after refreshing, and identifies that the number of currently updated feeds is 20.

The integrated SNS widget 200 may include a refresh image icon 230. When a user activates, that is, selects, the refresh image icon 230, SNS service information is received from an SNS server that is previously registered in a widget provider and a displayed feed is updated. While refreshing, the refresh image icon 230 may be animated.

A user input area 240 denotes an area to which information may be input by a user. A new user interface to which a user may input information may be displayed in response to activation of the user input area 240 according to a user's selection.

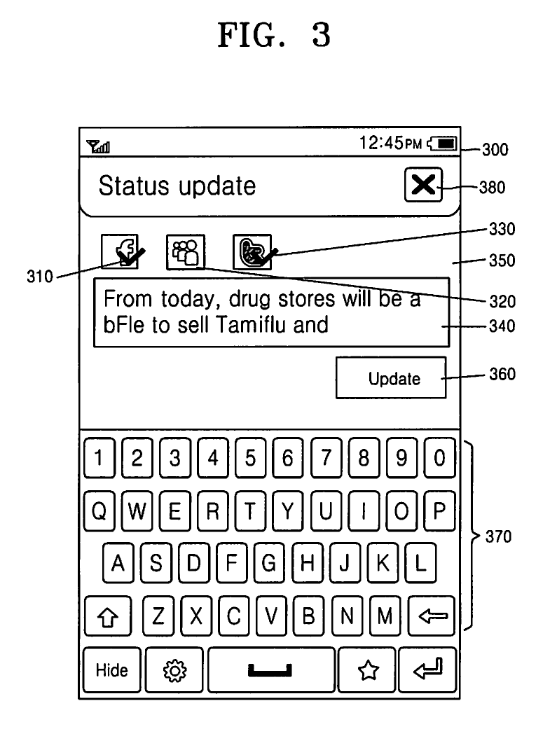

FIG. 3 illustrates a user interface to which information may be input according to an embodiment of the present invention.

Referring to FIG. 3, unique icons 310 through 330 of a registered SNS service provider are displayed. According to a user's selection, an SNS server to be updated may be set. In this case, input information may be updated only in the selected SNS server. Services registered when firstly entering the user interface may be previously selected. In FIG. 3, it is indicated that the icon at the left and the icon at the right are determined as SNS servers to be updated according to a user's selection.

The icons 310, 320 and 330 are selected and unselected in a toggle form. An input area 340 denotes an area to which data is input by a user. The user may input text data to be updated to the input area 340, and the number of letters input by the user may be counted. The number 140 indicated by reference numeral 350 denotes the number (or capacity) of input letters. When input of letters is completed, the user updates the input letters to the selected SNS server by using an update button 360. A user interface 300 which may input information may include a keyboard 370 for inputting, and the user interface 300 which may input information may include a close button 380 for cancelling the user interface 300. When the close button 380 is activated, a state returns to its previous state, that is, the interface screen illustrated in FIG. 2.

When an amount of input data (the number of letters) exceeds a threshold value, some SNS servers may not be updated. For example, when the number of letters in Twitter is 140 or above, the SNS server may not be updated. In this case, a unique icon of a corresponding SNS service provider is unselected, and the icon is dimmed. Also, when the number of letters reaches a threshold value, a warning popup may be displayed.

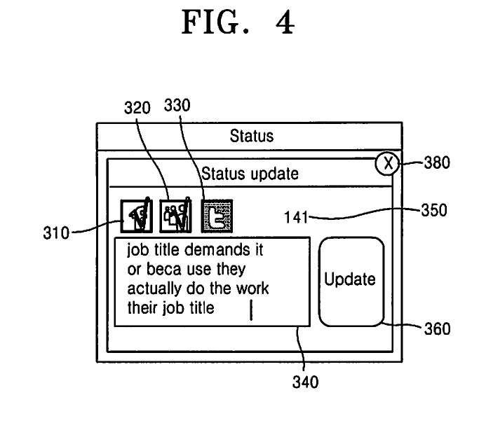

FIG. 4 is illustrates an interface screen related to limitation in the number of letters.

The interface screen of FIG. 4 is the same as that of FIG. 3 and thus details of each function are omitted for purposes of conciseness. It is assumed that the number of letters of an SNS service provider at the right that corresponds to the icon 330 is limited to 140. The number of letters input in the current input area is 140 and thus exceeds an allowable limit. In this case, the icon 330 of the corresponding SNS service provider is unselected and is dimmed.

Referring back to FIG. 2, feed information areas 250 through 270 display feed information received from a plurality of SNS servers. In the feed information areas 250 through 270, unique identifiers 251, 261, and 271 of the plurality of SNS servers may be displayed, such as identification icons of SNS programs. Also, identifiers of a register for feed information, such as a photograph, a name, a registered text, an image and/or currently updated time, may be displayed in each feed area. Also, icons 252, 262, 263, and 272 used to execute functions for the received feed information may be displayed.

The functions may include, for example, viewing the corresponding feed information in detail, inputting information in correspondence to the corresponding feed information, refreshing for update, and displaying the number of comments. The functions may be changed and expanded by a manufacturer. When plurality of feed information is displayed, feed information is displayed according to updated time order. Referring to FIG. 2, feed information 252 disposed at the top is feed information that is most currently updated.

A setting icon 280 is used to set a function of an integrated SNS widget based on a user's response. For example, automatic refreshing setting, by which feed information is automatically received from the plurality of SNS servers by a time interval, and turning a function of the integrated SNS widget may be set.

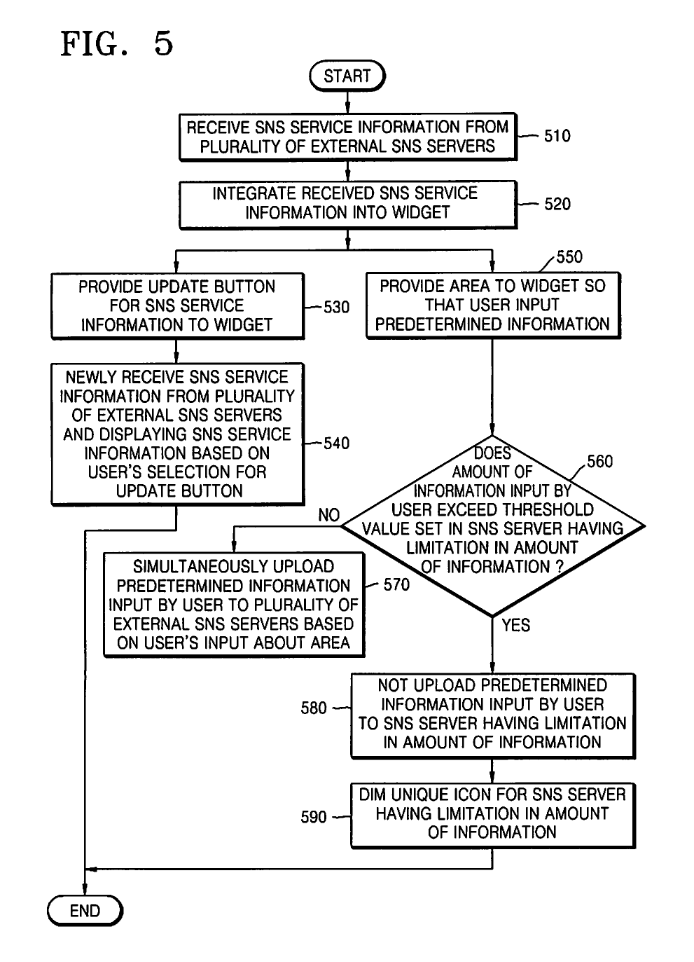

FIG. 5 illustrates a method of providing SNS widget, according to an embodiment of the present invention.

Referring to FIG. 5, an apparatus for providing the SNS widget receives SNS service information from a plurality of external SNS servers, in operation 510. The apparatus for providing SNS widget may receive SNS service information from some of the SNS servers from the plurality of external SNS servers based on a user's selection.

In operation 520, the apparatus integrates the received SNS service information into widgets. The apparatus for providing SNS widget may display the received SNS service information according to a received time order.

In operation 530, the apparatus provides an update button to the integrated SNS widget for the SNS service information.

In operation 540, the apparatus newly receives SNS service information from the plurality of external SNS servers and displays the newly received SNS service information based on a user's selection for the update button. As another example, automatic updating may be available in a time interval regardless of a user's selection.

In operation 550, the apparatus provides an area to the integrated SNS widget so that a user may input information.

In operation 560, the apparatus determines whether an amount of information input by a user exceeds a threshold value set in an SNS server having an amount of information limitation.

When the amount of information does not exceed the threshold value, in operation 570, information input by a user is simultaneously uploaded to the plurality of SNS servers based on an input of a user about the area or information input by a user is simultaneously upload to some SNS servers from among the plurality of SNS servers based on a user's selection.

When the amount of information exceeds the threshold value, in operation 580, the apparatus for providing SNS widget does not upload information input by a user to the SNS server having limitation in an amount of information and instead, in operation 590, the apparatus for providing SNS widgets dims a unique icon for the SNS server having an amount of information limitation.

The method of providing SNS widget can also be embodied as computer readable codes on a computer readable recording medium. The computer readable recording medium is any data storage device that can store data, which can be thereafter read by a computer system. Examples of the computer readable recording medium include ROM, RAM, CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A method of providing a Social Network Service (SNS) widget, the method comprising:
receiving SNS service information from a plurality of external SNS servers; and
integrating the received SNS service information into the widget.

2. The method of claim 1, wherein the receiving of the SNS service information comprises receiving SNS service information from some but not all of the SNS servers from among the plurality of external SNS servers based on a user's selection.

3. The method of claim 1, further comprising:
providing an update button about the SNS service information to the widget; and
newly receiving SNS service information from the plurality of external SNS servers based on a user's selection about the update button and displaying the newly received SNS service information to the widget.

4. The method of claim 1, further comprising periodically receiving SNS service information according to a time interval and displaying the received SNS service information.

5. The method of claim 1, wherein the displaying the received SNS service information to the widget comprises displaying the received SNS according to a received time order.

6. The method of claim 1, further comprising:
providing an area in the widget so that a user may input information; and
simultaneously uploading the information input by the user to the plurality of external SNS servers based on a user's input about the area.

7. The method of claim 6, wherein the uploading comprises uploading the information input by the user to some but not all of the SNS servers from among the plurality of external SNS servers based on a user's selection.

8. The method of claim 6, further comprising not uploading the information input by the user to a SNS server having an amount of information limitation, when an amount of information input by the user exceeds a threshold value set in the SNS server having a limitation in an amount of information.

9. The method of claim 8, further comprising dimming a unique icon for the SNS server having the amount of information limitation.

10. An apparatus for providing a Social Network Service (SNS) widgets, the apparatus comprising:
a display unit for displaying the SNS widgets;
a communication unit for receiving SNS service information from a plurality of external SNS servers; and
a control unit for integrating the received SNS service information into the widgets.

11. The apparatus of claim 10, wherein the control unit selects some but not all of the SNS servers from among the plurality of external SNS servers based on a user's selection and controls to receive SNS service information from the selected SNS servers.

12. The apparatus of claim 10, wherein the control unit provides an update button about the SNS service information to the widget and controls to newly receive SNS service information from the plurality of external SNS servers based on a user's selection about the update button.

13. The apparatus of claim 10, wherein the control unit periodically receives SNS service information according to a time interval and displays the newly received SNS service information.

14. The apparatus of claim 10, wherein the display unit displays the received SNS service information according to a received time order.

15. The apparatus of claim 10, wherein the control unit controls to provide an area to the widget so that a user may input information and to simultaneously upload the information input by the user to the plurality of external SNS servers according to a user's input about the area.

16. The apparatus of claim 15, wherein the control unit controls to simultaneously upload information input by the user to some SNS servers from among the plurality of external SNS servers according to a user's selection.

17. The apparatus of claim 15, wherein the control unit controls to not upload the information input by the user to a SNS server having an amount of information limitation, when an amount of information input by the user exceeds a threshold value set in the SNS server having a limitation in an amount of information.

18. The apparatus of claim 17, wherein the control unit controls to dim a unique icon for the SNS server having the limitation in an amount of information.

19. A computer readable recording medium having embodied thereon a computer program for executing a method of providing Social Network Service (SNS) widget comprising: receiving SNS service information from a plurality of external SNS servers, and integrating the received SNS service information into the widget.
